(19) United States
(12) Patent Application Publication
(10) Pub. No.: US 2004/0222625 A1
(43) Pub. Date: Nov. 11, 2004

(54) Combination synthetic or paper label mounted on the same release liner with a different synthetic or paper label with or without backer cut

(76) Inventors: Jean-Luc Major, Montreal (CA); Julie Trinque, Laval ouest (CA); David Ralph Emmert, Angola, IN (US)

Correspondence Address: NIXON & VANDERHYE, PC, 1100 N GLEBE ROAD, 8TH FLOOR, ARLINGTON, VA, 22201-4714, US

(21) Appl. No.: 10/431,512

(22) Filed: May 8, 2003

(51) Int. Cl. B42D 15/00

(52) U.S. Cl. 283/81

(57) ABSTRACT

A composite label form includes a release liner coated with an adhesive release material. A first label of a first material includes an adhesive on a back surface and is releasably attached to the release liner. At least one space is die cut from the first material, and a second label of a second material different from the first material is releasably attached to the same release liner. The second material also includes an adhesive on a back surface thereof. The label form may also include a backer die cut adjacent at least one of the first label or the second label such that a portion of the release liner will be removed when the adjacent label is removed from the liner. This construction provides for multiple label types on a single release liner, with or without a backer die cut.

### CROSS-REFERENCES TO RELATED APPLICATIONS

(NOT APPLICABLE)

### STATEMENT REGARDING FEDERALLY SPONSORED RESEARCH OR DEVELOPMENT

(NOT APPLICABLE)

### BACKGROUND OF THE INVENTION

The present invention relates to composite label forms and, more particularly, to a composite label form and method of constructing a composite label form including labels of different materials on a common release liner with or without a backer cut.

There is a market need to have multiple face materials on one single liner in a horizontal position (alternating on top of each other). Most printers use a single face material on a single liner. In the past few years, in-house label printing has saved companies millions of dollars in costs. Up until the 1970's, industries were buying its label products pre-printed through a professional printer. With the invention of the thermal printer and direct thermal printers, many industries started to see benefits of doing their own printing in house (with professional printer supplying blank or semi-printed labels). Many businesses use thermal printing, laser, and direct thermal printing, as a main method of label printing. This type of printing is cost effective and simple if a professional printer supplies the single blank labels (or they may have the printer print static copy or backgrounds on the blanks) so they can in-print the label. To lower costs even more and make the operation more productive, the addition of one or more different materials to the liner, that feeds the product into the printer (in the horizontal position), will further lower costs with better ergonomics, efficiencies, and added productivity.

Different label types are typically printed on different label forms using multiple printers. For example, shipping labels are typically printed on one printer, while UL labels are printed on another. Aside from the inefficiency of using multiple printers, problems arise in matching labels printed on two different printers for shipping.

### BRIEF SUMMARY OF THE INVENTION

To overcome these problems, it would be desirable to utilize a composite label form including different label types on a single form. The label material face is typically a paper or synthetic. This material will have an adhesive on the backside of the face material. The material and adhesive are attached to a liner, which feeds into the printer so marginal information can be printed onto it. This is a single material operation. Printers typically use different print modes including direct thermal, thermal transfer, laser, or impact type printers. Most printers use a single material construction when printing a label for a carton, merchandise, or other product that needs to have a label for some sort of identification. There are times, however, when a carton, merchandise, or other product may need multiple labels with different face materials. When different labels are applied onto a product then typically the end user purchases a printer to put them through as single constructions for each label required. A product requiring two, three, four or more different labels to be put on the liner requires more money to be spent on printers; more people to run the printers; and more repair and/or consumables to be expensed.

The present invention provides at least two different label materials, for example one paper and the other a UL polyester film or the like, mounted on the same release-coated carrier without the use of a piggyback label or a release varnish on top of the base label as is normally the case. A bottom portion of the base paper label can be die cut matrix waste removed to allow the affixing of a second label of different material taking its place. A black timing mark may be printed on the back of the liner, which serves to initiate the imaging sequence of a thermal transfer printer. The addition of a backer die cut through the liner provides additional advantages to the end user.

In an exemplary embodiment of the invention, a composite label form includes a release liner coated with an adhesive release material; a first label of a first material including an adhesive on a back surface, the first label being releasably attached to the release liner; and a second label of a second material different from the first material and including an adhesive on a back surface, the second label being releasably attached to the release liner. Preferably, the first and second labels are positioned along a lengthwise direction of the form. In one embodiment, the first material is paper, and the second material is synthetic. Alternatively, the second material may be one of polyester or Tyvek®.

The composite label may include a plurality of first labels of the first material and a plurality of second labels of the second material. Preferably, at least one of the first material and the second material is UL certified.

The release liner may include a backer die cut adjacent at least one of the first label or the second label such that a portion of the release liner will be removed when the at least one of the first label or the second label is removed from the liner. In this context, the backer die cut is preferably sized to leave a frame of exposed adhesive when the at least one of the first label or the second label is removed from the liner.

In another exemplary embodiment of the invention, a method of constructing a composite label includes the steps of (a) providing a base label material including a release liner coated with an adhesive release coating and a first material covering the release liner and including an adhesive on a back surface, the first material being releasably attached to the release liner; (b) die cutting the first material into at least one first label and including space for at least one second label; (c) removing waste material resulting from step (b); and (d) applying at least one second label of a second material different from the first material and including an adhesive on a back surface to the space for the at least one second label.

### BRIEF DESCRIPTION OF THE DRAWINGS

These and other aspects and advantages of the present invention will be described in detail with reference to the accompanying drawings, in which:

FIG. 1 shows the base label material with a space die cut to accommodate a second label;

FIG. 2 shows the composite label form with exemplary different label types;

FIG. 3 is a cross sectional view through line III-III in FIG. 2; and

FIG. 4 is an exemplary alternative embodiment showing multiple different materials on a common liner.

### DETAILED DESCRIPTION OF PREFERRED EMBODIMENTS

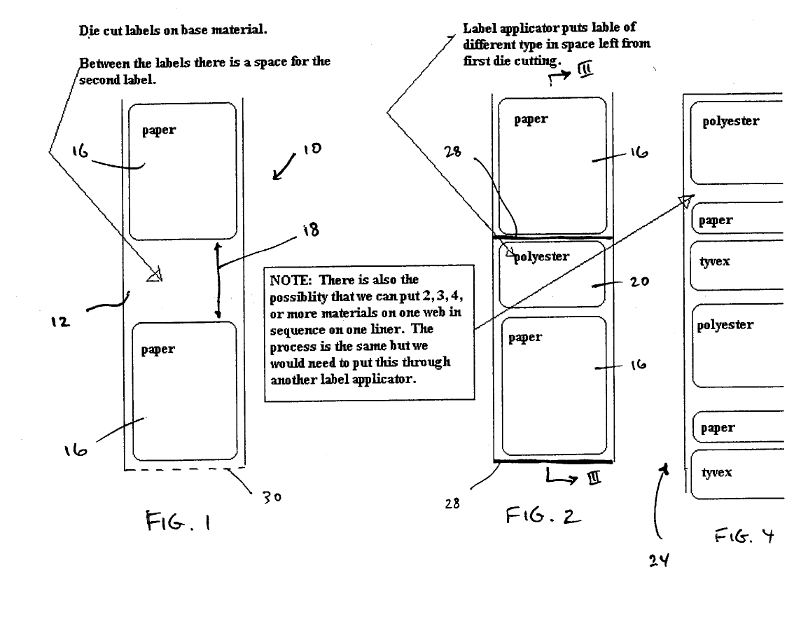

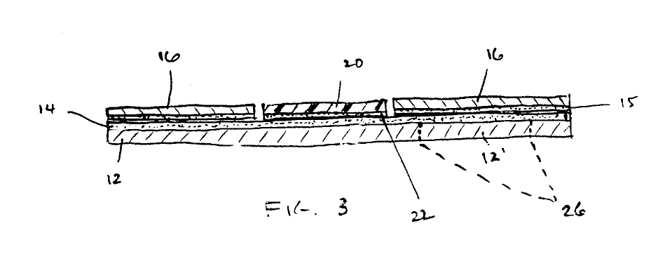

With reference to FIGS. 1-3, the composite label form 10 of the present invention includes a release liner 12 coated with an adhesive release material 14 such as silicone or the like. For ease of illustration, the size of the layers in FIG. 3 are greatly exaggerated. A first material such as paper or synthetic including an adhesive layer 15 on a backside thereof is releasably secured to the release liner 12. This base construction may then be printed if needed. Subsequently, using a conventional die cutting apparatus, the first material is die cut into one or more first labels 16 (two shown in FIG. 1), leaving one or more spaces 18 for a corresponding one or more second labels. A printing cycle may alternatively or additionally be carried out after die cutting. Subsequently, the partially-completed form can be put on rolls or fanfolded, depending on production need.

The rolls or fanfolds are brought to a suitable label applicator, and at least one second label 20 of a second material different from the first material is applied in the one or more spaces 18 on the label form 10. In an exemplary embodiment, the second material 20 can be a UL polyester label. The second label 20 includes an adhesive layer 22 on a back surface thereof for releasably adhering the label to the release liner 12.

In a preferred embodiment of the invention, the composite label form 10 includes labels of two different materials such as a paper label used for shipping and transportation purposes and a synthetic label that is UL certified. The labels are preferably mounted in a horizontal position on one web. Of course, as shown in FIG. 4, multiple combinations of materials and die cuts can be associated on a common liner. FIG. 4 illustrates a composite label form 24 including labels of paper, polyester and Tyvek®. Exemplary paper materials may include Litho, MHP, Semi-gloss, Gloss, Thermal, Direct Thermal, Latex Impregnated, Metalized, UL certified products and other specialty paper products that may be developed; while exemplary synthetic materials may include UL certified synthetics, polyester, polypropylene, polystyrene, vinyl, acetone/acetate, Tyvek@, Kimdura, Valeron, Polyolefin, Retro reflective, Foil, Polyimide, and other specialty synthetic materials that may be developed. Of course, those of ordinary skill in the art will contemplate alternative materials suitable as labels for the composite label form, and the invention is not necessarily meant to be limited to the illustrated example.

A black timing mark, punched through sensor eye mark, or other printed or die cut feature 28 can be used as a timing sensor for later use by an applicator or secondary printer. An exemplary black timing mark 28 is shown in FIG. 2. Additionally, perforations 30 can be added if necessary as shown in FIG. 1.

With continued reference to FIG. 3, in addition to the material combination, the composite label form 10 of the present invention may include a backer die cut 26 just through the liner 12. In this context, with the backer die cut 26 through the liner 12 adjacent at least one of the first label or the second label, a portion 12′ of the released liner 12 will be removed when the corresponding label is removed from the liner. The backer die cut 26 may be sized to leave a frame of exposed adhesive 15 when the adjacent label is removed. With the backer die cut 26, the adjacent label can be removed with greater ease, and information on the label can be retained without the adhesive being exposed. Moreover, the backer die cut 26 enables the label to be used in a second application, although a smaller dimension due to the fact that the original material with the adhesive on it will remain attached to the adhered product. Still further, the backer cut 26 on the form allows the end user to expose a window of information under the non-adhesive portion of the decal (return information, bar code, inspection sticker and the like). Of course, the backer die cut 26 can be any size but preferably is at least smaller than the adjacent label to leave a frame of exposed adhesive on the decal.

With the composite label form of the present invention, multiple label types can be included on a common release liner, thus eliminating exemplary problems discussed in the Background section of the present specification relating to matching shipping and transportation labels with UL labels printed on separate printers. The addition of a backer die cut provides added functionality to the composite label form.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A composite label form comprising:
a release liner coated with an adhesive release material;
a first label of a first material including an adhesive on a back surface, the first label being releasably attached to the release liner; and
a second label of a second material different from said first material and including an adhesive on a back surface, the second label being releasably attached to the release liner.

2. A composite label form according to claim 1, wherein the first and second labels are positioned along a lengthwise direction of the form.

3. A composite label form according to claim 1, wherein the first material is paper, and wherein the second material is synthetic.

4. A composite label form according to claim 1, wherein the first material is paper, and wherein the second material is one of polyester or Tyvek®.

5. A composite label form according to claim 1, comprising a plurality of first labels of said first material and a plurality of second labels of said second material.

6. A composite label form according to claim 1, wherein at least one of the first material and the second material is UL certified.

7. A composite label form according to claim 1, wherein the release liner comprises a backer die cut adjacent at least one of the first label or the second label such that a portion of the release liner will be removed when the at least one of the first label or the second label is removed from the liner.

8. A composite label form according to claim 7, wherein the backer die cut is sized to leave a frame of exposed adhesive when the at least one of the first label or the second label is removed from the liner.

9. A method of constructing a composite label form, the method comprising:
(a) providing a base label material including a release liner coated with an adhesive release coating and a first material covering the release liner and including an adhesive on a back surface, the first material being releasably attached to the release liner;
(b) die cutting the first material into at least one first label and including space for at least one second label;
(c) removing waste material resulting from step (b); and
(d) applying at least one second label of a second material different from said first material and including an adhesive on a back surface to the space for the at least one second label.

10. A method according to claim 9, wherein step (b) is practice by die cutting the first material such that the first label and the at least one second label are positioned along a lengthwise direction of the form.

11. A method according to claim 9, further comprising (e) backer die cutting the release liner adjacent at least one of the first material or the second material such that a portion of the release liner will be removed when the at least one of the first material or the second material is removed from the liner.

12. A method according to claim 11, wherein step (e) is practiced by sizing the backer die cut to leave a frame of exposed adhesive when the at least one of the first material or the second material is removed from the liner.

13. A method according to claim 9, wherein steps (b) and (d) are practiced to form a plurality of first labels of said first material and a plurality of second labels of said second material.
